(19) United States
(12) Patent Application Publication
(10) Pub. No.: US 2015/0294379 A1
(43) Pub. Date: Oct. 15, 2015

(54) METHOD AND APPARATUS TO INTRODUCE BILLING ARCHITECTURE FOR DIFFERENT UTILITY EVENTS AND TO GRANT CROSS DOMAIN PROMOTIONS

(71) Applicant: TELEFONAKTIEBOLAGET L M ERICSSON (PUBL), Stockholm (SE)

(72) Inventors: Vivek GIRIDHARAN, Chennai (IN); Senthil Kumar KARUPANAN SUBRAMANIAN, Chennai (IN); Saravanan MOHAN, Chennai (IN); Angammai SUBBIAH, Chennai (IN); Balaji TIRUVENGADAM, Chennai (IN)

(73) Assignee: TELEFONAKTIEBOLAGET L M ERICSSON (PUBL), Stockholm (SE)

(21) Appl. No.: 14/250,017

(22) Filed: Apr. 10, 2014

(51) Int. Cl. G06Q 30/04; G06Q 30/02; G06N 5/02

(52) U.S. Cl. CPC G06Q 30/04; G06N 5/027; G06Q 30/0222

(57) ABSTRACT

A billing arrangement continuously receives messages from a variety of service providing entities, the messages being associated with consumption of the user in a variety of service domains, compares, for at least some of the service domains, the consumption within the service domain with a corresponding consumption threshold, if the consumption threshold is crossed, gives the user at least one reward in relation to at least one further service domain, computes a bill based on the degree of consumption within all service domains using corresponding charging rates while considering rewards given to the user and bills the user using the computed bill with possible rewards.

### TECHNICAL FIELD

The invention relates to billing of users. More particularly, the invention relates to a billing device, method and computer program product for providing unified billing of the consumption made by a user in a number of different service domains.

### BACKGROUND

Electronic payments are becoming more and more common. It is today also possible to use a mobile phone as a tool in economic transactions.

It is also known to send electronic bills or invoices. However, such bills are then sent from different individual service providers or utility vendors to a user. There is no correlation between the bills. This means that the end user has to actively invest time and effort in monitoring and settling different payments for different utility vendors. Furthermore possible promotion schemes used by the utility vendors are also separated from each other.

In short, users can today purchase goods in a simple and efficient manner. However, the billing and payment still remains the same.

There is therefore a need for providing unified billing. It would furthermore be of interest if this unified billing could be used together with more advanced promotion schemes.

Aspects of the invention are directed towards solving this problem.

### SUMMARY

One object of the invention is thus to provide unified billing together with cross-domain promotions.

According to a first aspect, this object is achieved by billing arrangement for providing unified billing of the consumption made by a user in a number of different service domains. The billing arrangement comprises a processor acting on computer instructions. Thereby the billing arrangement is operative to continuously receive messages from a variety of service providing entities, where the messages are associated with consumption of the user in a variety of service domains, compare, for at least some of the service domains, the consumption within the service domain with a corresponding consumption threshold, if the consumption threshold is crossed, give the user at least one reward in relation to at least one further service domain, compute a bill based on the degree of consumption within all service domains using corresponding charging rates while considering rewards given to the user, and bill the user using the computed bill with possible rewards 1.

According to a second aspect, this object is achieved by a method for providing unified billing of the consumption made by a user in a number of different service domains. The method is performed in a billing arrangement and comprises continuously receiving messages from a variety of service providing entities, where the messages are associated with consumption of the user in a variety of service domains, comparing, for at least some of the service domains, the consumption within the service domain with a corresponding consumption threshold, if the consumption threshold is crossed, giving the user at least one reward in relation to at least one further service domain, computing a bill based on the degree of consumption within all service domains using corresponding charging rates while considering rewards given to the user, and billing the user using the computed bill with possible rewards.

According to a third aspect, this object is achieved through a computer program for providing unified billing of the consumption made by a user in a number of different service domains. The computer program product is provided on a data carrier comprising computer program code which when run in a billing arrangement, causes the billing arrangement to: continuously receive messages from a variety of service providing entities, where the messages are associated with consumption of the user in a variety of service domains, compare, for at least some of the service domains, the consumption within the service domain with a corresponding consumption threshold, if the consumption threshold is crossed, give the user at least one reward in relation to at least one further service domain, compute a bill based on the degree of consumption within all service domains using corresponding charging rates while considering rewards given to the user, and bill the user using the computed bill with possible rewards.

The invention according to the above-mentioned aspects has a number of advantages, where some are listed here. It provides unified billing together with cross-domain promotions, which simplifies the handling of bills for both user and service providers. It also enables seamless handling of information across domains and provides the user as well as the service providers with benefits. It is also easy to combine with various M-commerce technologies in order to simplify transactions for both users and service providers.

In an advantageous variation of the first aspect, the billing arrangement is further configured to when giving at least one reward, give a first reward in relation to the service domain as well as at least one further reward in relation to said at least one further service domain.

In a corresponding variation of the second aspect, the giving of at least one reward comprises giving a first reward in relation to said service domain as well as at least one further reward in relation to said at least one further service domain.

According to another variation of the first aspect, the billing arrangement is further configured to notify the user of at least one reward and only consider a notified reward in the billing if it is accepted.

According to a corresponding variation of the second aspect, the method further comprises notifying the user of at least one reward and only considering a notified reward in the billing if it is accepted.

According to a further variation of the first aspect, the billing arrangement is further configured to create uniform usage data records based on the content of the messages, where a usage data record comprises data specifying the degree of consumption and the service domain, when being configured to compare the consumption with a corresponding consumption threshold is configured to compare the data specifying the degree of consumption in the usage data records associated with the service domain in question with the threshold and when being configured to compute a bill is configured to compute a bill based on the degree of consumption in the usage data records.

According to a corresponding variation of the second aspect, the method further comprises creating uniform usage data records based on the content of the messages, where a usage data record comprises data specifying the degree of consumption and the service domain, wherein the comparing of the consumption with a corresponding consumption threshold comprises comparing the data specifying the degree of consumption in the usage data records associated with the service domain in question with the threshold and the computing of a bill comprises computing a bill based on the degree of consumption in the usage data records.

The billing may be made at recurring regular intervals.

According to yet another variation of the first aspect, the billing arrangement is further configured to receive a status query from the user concerning the consumption in one or more of the service domains and respond to the query with data about the consumption.

According to a corresponding variation of the second aspect, the method further comprises receiving a status query from the user concerning the consumption in one or more of the service domains and responding to the query with data about the consumption.

According to yet a further variation of the first aspect, the billing arrangement is further configured to obtain a change of the charging rate of the user in relation to a service domain and report the change to a corresponding service providing entity.

According to a corresponding variation of the second aspect, the method further comprises obtaining a change of the charging rate of the user in relation to a service domain and reporting the change to a corresponding service providing entity.

The association of the messages to the specific user may be made using a telecommunication network identifier of the user.

According to another variation of the first aspect, the billing arrangement is further configured to receive a change of telecommunication network identifier of the user and report the change to the service providing entities.

According to a corresponding variation of the second aspect, the method further comprises receiving a change of telecommunication network identifier of the user and reporting said change to the service providing entities.

The billing arrangement may be provided as a part of a telecommunication system. It may more particularly be provided in the core network of a mobile communication system.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings.

FIG. 1 schematically shows a telecommunication system comprising a billing arrangement communicating with a number of service providing entities.

FIG. 2 shows a block schematic of a first way of realizing the billing arrangement.

FIG. 3 shows a block schematic of a second way of realizing the billing arrangement.

FIG. 4 shows a flow chart of method steps in a method for providing unified billing of the consumption made by a user according to a first embodiment.

FIG. 5 schematically shows a number of method steps being performed by the billing arrangement for obtaining uniform usage data records.

FIG. 6 shows a flow chart of method steps in a method for providing unified billing of the consumption made by a user according to a second embodiment.

FIG. 7 shows a computer program product comprising a data carrier with computer program code for implementing the functionality of the billing arrangement.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known arrangements, devices, circuits and methods are omitted so as not to obscure the description of the invention with unnecessary detail.

There has today evolved a number of techniques that are directed towards so called electronic commerce or e-commerce. One branch of e-commerce is mobile commerce or m-commerce. M-commerce has a vital role to play in the adoption of the next generation of mobile payment mechanisms based on contactless technology. Banks (in tandem with card schemes) have begun to make a concerted effort to promote contactless products in collaboration with retailers. The role of m-commerce is central to the future evolution of mobile payments. The endgame will see consumers using mobile devices as real and virtual wallets, and the first step towards this is to encourage the linking of card accounts to mobile devices.

Mobile Wallet is an electronic account dominated in a currency, held on a mobile phone that can be used to store, and transfer value. Using one's handset as a financial tool, or the mobile wallet, is an interesting concept which is becoming increasingly popular and integrated across consumer platforms. Not only does it allow users on the move to access financial accounts, but also plays an integral part in the development of digital commerce and banking.

The mobile wallet is proving especially effective in developing countries where desktop access to the Internet and banking opportunities are still a privilege, yet mobile accessibility is extremely high. Except for software and technology, a range of other factors must be put in place before a mobile wallet can be launched. These steps include everything from defining the most attractive services, how the services should create the best user experience, ensuring compliance with rules and regulations, as well as tapping into existing revenue streams and networks for mobile money solutions and alliances.

Mobile Money refers to payment services operated under financial regulation and performed from or via a mobile device. It is an alternative payment method. Instead of paying with cash, check, or credit cards, a consumer can use a mobile phone to pay for a wide range of services and digital or hard goods. It provides a fully integrated system for users to make payment and transfer money in a very simple and convenient way.

Near-field communication (NFC) is the largest market opportunity in mobile payments by value, but cannot be tapped in the short term. Therefore, m-commerce offers the best target for ecosystem players to concentrate upon. Alongside m-commerce, the two other key segments of mobile payments are NFC and peer-to-peer (P2P) payments. NFC payments are contactless payments made possible by the physical proximity of an NFC-enabled device to a contactless point-of-sale (PoS) terminal. In effect, the same kind of contactless chip that is available in payment cards is embedded, inserted or attached to a mobile handset to enable the device to replace a contactless card in the payment transaction. P2P payments are transfers of money (or another store of value such as mobile phone credit) between individual consumers using mobile handsets. This category covers transactions between consumers in the same country as well as those carried out cross-border.

In view of various e-commerce technologies that have emerged there is thus a need for unified billing combined with cross-domain promotions. There is here proposed a solution that will enable unification of the billing process of the customer while at the same time granting the end user customized cross domain promotions using the mobile network. The aim is to provide “One bill for all usages of the End user” through advanced cellular technology.

As can be seen above, it is nowadays possible for a user to make purchases in different service domains using the mobile terminal itself. It may for instance be of interest to link purchases to the mobile terminals and more particularly to an identifier of the mobile terminals, such as to the Mobile Station International Subscriber Directory Number (MSISDN).

However, it would in this case be of interest that the user receives one bill for the purchases in at least some of the different service domains. If the purchases are concentrated to one bill, then the total number of bills of the user is reduced. This makes it easier for the user to keep track of bills. A user having many different bills may simply miss to pay one, with a consequential reminder and reminder fee.

It may also be of interest to the various service domain operators to concert their efforts, since then only one of the operators need to keep track of payment of the bill. There is thus also an administration efficiency involved with unified billing.

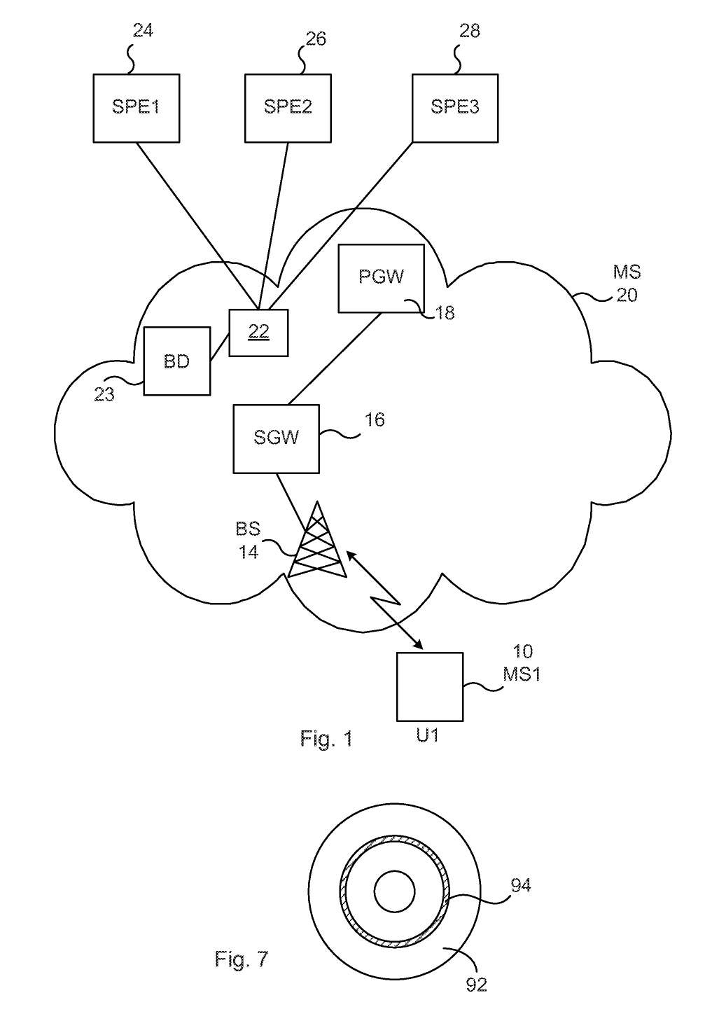

FIG. 1 schematically shows a telecommunication network, which more particularly is an exemplifying mobile telecommunication network MN 20. This network is an environment that with advantage may be used in order to provide unified billing and advanced promotion schemes in the form of cross-domain promotions.

The mobile communication network 20 comprises a base station BS 14 connected to a serving gateway SGW 16. The serving gateway 16 is in turn connected to a PDN Gateway PGW 18, where PDN is an acronym for Packet Data Network. In the mobile communication network 20 there is also a billing arrangement 22 and a network billing device BD 23 connected to the billing arrangement 22. The network billing device 23 is a device that is responsible for the billing of the services of the telecommunication network itself and may be a so-called Charging and Billing system.

It should be realized that the mobile communication network 20 may comprise several more devices. There may also be more devices of the same type, such as PGWs, SGWs and base stations. The mobile communication network may furthermore be a network allowing Internet connectivity such as Long Term Evolution (LTE) or Wideband Code Multiple Access (WCDMA). Aspects of the invention will in the following be described in relation to the mobile communication network 20. However, the telecommunication network is not limited to mobile communication networks, but may for instance be a Public Switched Telecommunication Network (PSTN).

The base station 14, which is often termed eNodeB or just NodeB, is provided in a part of the mobile communication network 20 termed access network, while the other devices are provided in a part of the mobile communication network 20 termed a core network. It can thereby be seen that the billing arrangement 22 is a part of a telecommunication system and more particularly provided in the core network of a mobile communication system.

A first user U1 of the mobile communication network 20 is furthermore equipped with a terminal 1o or a mobile station MS1, via which he or she may communicate with other users via the mobile communication network 20. The mobile station 10 is shown as communicating with the base station 14. The user U1 and his/her mobile station 10 is only shown for indicating that the environment may have users that may purchase goods, services or utilities needing to be billed. It should be realized that the mobile communication network normally does comprise several more users and terminals. A mobile station may furthermore be any type of cellular phone, where one example is a smart phone. It may also be a computer such as palm top or a lap top computer.

As can be seen in FIG. 1, the billing arrangement 22 is also connected to a number of entities outside of the mobile network 20. The billing arrangement 22 is as an example connected to a first Service Providing Entity SPE1 24, to a second Service Providing Entity SPE2 26 and to a third Service Providing Entity SPE3 28. Each service providing entity provides some kind of service or utility to users of the network 20, for instance to the first user U1. The services or utilities provided by the entities may furthermore different from each other. They are thus providing services or utilities in different domains. One entity may be a fuel providing entity, another may be a power providing entity and a third may be a media providing entity. A service providing entity may be a single device. However, it is also possible that there are several different devices. A fuel providing entity may for instance comprise several service providing devices, which may be physically as well as geographically separated from each other.

The billing and charging systems of telecommunication systems, such as the billing device 23, comprise Business Support and Control System (BSCS) and Charging System. The BSCS can be used, for example, for business partner rating and reconciliation, maintenance of taxation data and application of taxes, online and offline charging of post-paid customers, and billing of customers. The Charging System can be used, for example, for online charging of both prepaid and post-paid customers. Offline charging for post-paid customers is possible but it does neither include batch processing of files nor versioning of product data and contracts.

An end user wanting to purchase services or utilities for various utility vendors today has to actively invest time and effort in monitoring and settling different payments for different utility vendors. In this situation the end user is not able to customize the benefits and not able to use the bonus points of one utility towards other utility payments.

When unified billing is provided, the unified utility billing is mainly suited for multi segment service providers. Such a service provider can have single billing and charging solution through which multi segment service providers will be able to collect and provide statistical analysis for their business improvement. Hence there is here provided a method where cellular technology can be used for unified billing. The technology is here also used for cross-domain promotions.

Billing in a service domain is generally performed according to a bill cycle. Using this information the billing arrangement will calculate cross-promotional options for the end user. To implement this there is here proposed an asynchronous architecture through which it is possible to process incoming data from various service providing entities.

One element of this architecture is a utility device, such as a service providing entity 24, 26 and 28, which will be able to provide the information for calculating the bill for the end users Utility usage, i.e. the usage of a utility or service provided by a service provider in a service domain. This entity will leverage on the Core Mobile Network's capability to handle data. The service providing entity will be able to send data packets containing information using a Mobile DATA Network. Once the Data Packets reach the Core Network of the mobile communication network 20 it is possible to use a “Processing Logic”, for instance provided by the billing device 23, to separate the data Packets from the normal traffic with device identification number (+unique subscriber number) present in the utility device data.

After splitting the data it is possible to use functionality in the billing device 23, such as so-called Account Information Refill (AIR) functionality to find subscriber details of the user U1 and use the data manipulator 54 to format the data.

In view of the above, it may be of interest to combine the purchases of a user U1 in various service domains to a common bill. Furthermore, since the user U1 may be a subscriber in the mobile communication network and many of the purchases may be made using the mobile terminal 10, it may also be of interest that such a common bill is provided by the operator of the mobile communication network 20. One reason for this is that the user is already being billed by the operator. Another is that if the purchase has been made using a mobile terminal of the user, then it is logical that the bill from the operator of the network 20 also reflects purchases made using the terminal 10.

The billing arrangement is provided for addressing the above mentioned situation as well as to provide cross-domain promotions. The billing arrangement 22 thus provides unified billing of the consumption made by the user in a number of different service domains and combines this with cross-domain promotions.

The mobile network 20 thus comprises data of the user U1 of the mobile terminal 10 and he or she is already receiving a bill for the use of this terminal 10 in the mobile communication network 20. Since the mobile terminal 10 may be used for other purchases or uses, it may therefore be of interest to also be debited from other vendors in the same bill.

Aspects of the invention will now be described in relation to the first user U1. The first user U1 may have purchased services from a number of different service providers or utility vendors, where the service providers provide services or utilities in different service domains. It is here possible that there is more than one service provider in a service domain. However, these do not normally have an agreement between each other regarding cross-promotions.

A user may consume units of a resource provided by a service provider according to a rate plan. A unit may be a purchased volume of gasoline, consumed electrical energy etc. For a certain user there is thus a rate plan for every service provider in each service domain. A rate plan, which may have been agreed upon by the user U1 and the service provider, may have been provided to the billing arrangement 22 by either the service provider or the user. The rate plan specifies how consumed units of the service are to be billed.

There is thus one rate plan for every service provider in a number of service domains. One service provider may be an energy service provider, which delivers electricity to the user, another may be a chain of gasoline stations. The rate plans may be stored in the rules configuration store 36.

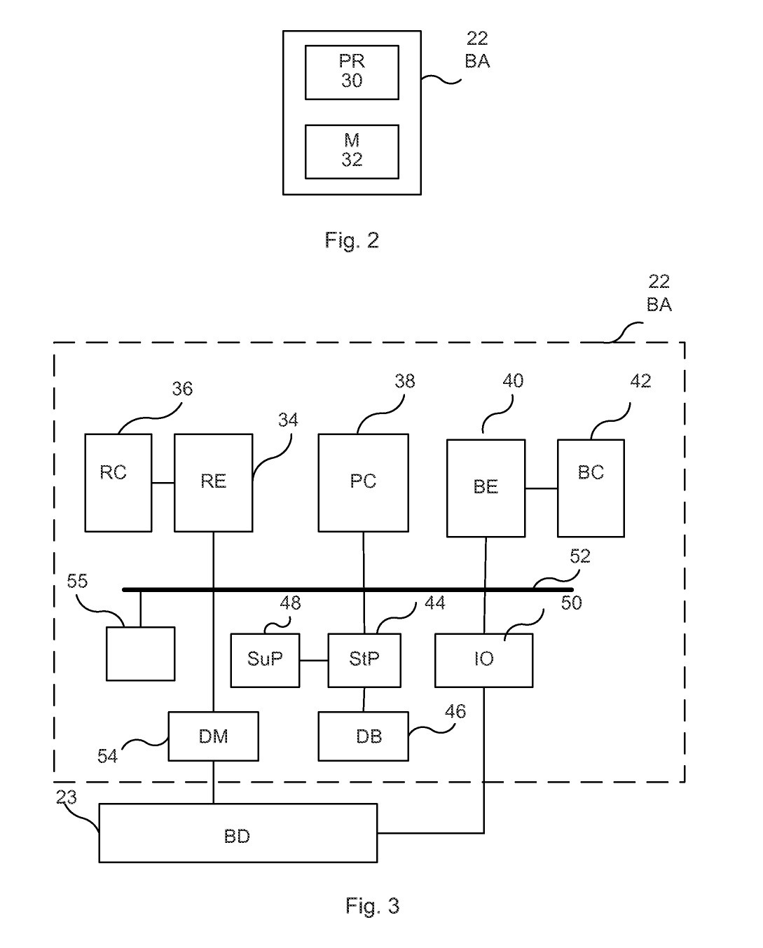

FIG. 2 shows a block schematic of a first way of realizing the billing arrangement BA 22. It may be provided in the form of a processor PR 30 connected to a program memory M 32. The program memory 32 may comprise a number of computer instructions implementing the functionality of the billing arrangement 22 and the processor 30 implements this functionality when acting on these instructions. It can thus be seen that the combination of processor 30 and memory 32 provides the billing arrangement 22.

FIG. 3 shows a block schematic of a second way of realizing the billing arrangement BA 22. The billing arrangement 22 may comprise a Rules Engine RE 34 connected to a Rules Configuration store RC 36. The billing arrangement 22 may also comprise a Promotions Calculator PC 38 and a Billing Engine BE 40, which billing engine is connected to a Billing Configurations store BC 42. The billing arrangement 22 also comprises an Input Output Unit IO 50 and a Storage Processor StP 44, where the storage processor 44 is also connected to a Subscriber Profiler SuP 48 as well as to a Database DB 46. There is also a data manipulator DM 54.

The Rules Engine 34, Promotions Calculator 38, Billing Engine BE 40, Input Output Unit 50, Storage Processor StP 44 and data manipulator 54 may be connected to an internal data communication system, which may be provided as a local data bus 52. The internal data communication network may comprise at least one buffer 55, such as a First In First Out (FIFO) buffer. The various units connected to the bus may read and write to the buffer 55 in order to handle the billing. The data manipulator 54 and the input output unit 50 may also be connected to the billing device 23. The Input Output Unit 50 is responsible for communicating with the Service Providing Entities as well as with the user U1 and may therefore be equipped with or connected to an external communication interface for instance in order to communicate with the Service Providing entities over the Internet.

The elements in FIG. 3 may be provided as software blocks, for instance as software blocks in a program memory, but also as a part of dedicated special purpose circuits, such as Application Specific Integrated Circuits (ASICs) and Field-Programmable Gate Arrays (FPGAs). It is also possible to combine more than one element in such a circuit.

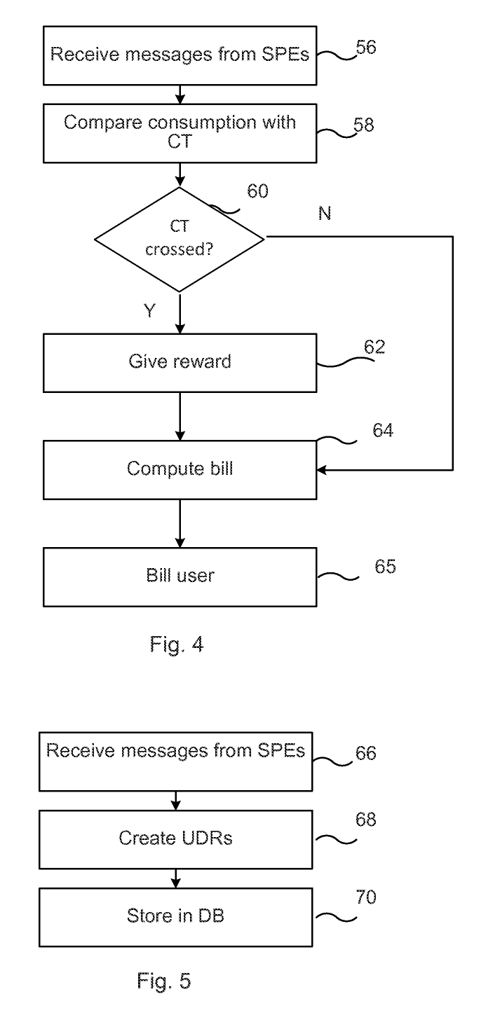

FIG. 4 is a flow chart of method for providing unified billing according to a first embodiment. As the user U1 makes s purchase or uses or consumes units of the service or utility at a service providing device of the service provider in the service domain, the unit consumption may be recorded together with the identity of the user. This identity may be provided as a telecommunication network identifier of the user for instance the MSISDN or the International mobile Subscriber Identity (IMSI) of the terminal 10. If as an example the user fills a car with gasoline, he or she may register the units of the service at the service provider. The data registered may comprise the amount of gasoline being obtained and the user identity, here the MSISDN. This data concerning the purchase may then be forwarded from a local utility device of the service provider to a central purchase handling device of the service provider. It is as an example possible that the first service providing entity 24 is such a central purchase handling device. There may in this case be a number of different purchases being made by the user from different local utility devices and the service providing entities may then send records of the various purchases to the arrangement 22. It is also possible that the individual local utility devices send data of the purchase directly to the arrangement 22. A service providing entity may therefore comprise a central purchase handling device as well as or one or more local utility devices.

Because of this, the input output unit 50 of the billing arrangement 22 may continuously receive messages from a variety of service providing entities 24, 26, 28, step 56, where the messages are associated with consumption of the user in a variety of service domains.

The input output unit 50 then makes the data of the messages accessible so for the rules engine 34, so that the rules engine 34 may process it. One way in which data may be made accessible is through forwarding the data to the storing processor 44 for storing in the database 46 in an area associated with the service providing entity. Another is through forwarding the data to the data manipulator 54, in order for the data manipulator 54 to create user data records associated with the service providing entities. Thereafter the data manipulator 54 may export the user data records to the data network 52 for being processed by the rules engine 34, the promotions calculator 38 and billing engine 42. A user data record may in this case reflect the number of units consumed, type of service or usage, which may be through identifying the service provider, as well as the identity of the consumer, like the MSISDN.

The user U1 may then be billed regularly, such as, once a week, every second week, one a month, every third month, once a year, etc.

In order to obtain this periodic unified billing, it is then necessary to regularly investigate the consumption of the user U1. Therefore the rules engine 34 may regularly, such as when it is time for billing the user, retrieve data of the consumption of the user U1 in the various service domains. It may for instance retrieve records of the consumption of the user, since the last bill in the various service domains. The records may furthermore be fetched and processed on a service domain by service domain basis.

The rules engine 34 therefore fetches, for each service domain, the records of the consumption of the user U1, either as a usage data record or through fetching data in an area in the database 46 where the data of the purchases has been stored. It then determines a billing of the usage based on default rules. It thereby applies default charging rates of the usage in the different service domains. Optionally the rules calculator 34 may inform the user, via the input output unit 50, that a threshold set by the user is about to be crossed.

The promotions calculator 38 is in turn responsible for determining of if rewards such as bonuses and/or discounts, are to be given or not. For this reason the promotions calculator 38 may compare, for at least some service domains and with advantage for all service domains, the consumption within the service domain with a corresponding or dedicated consumption threshold, step 58. It thus compares, for at least some of the service domains, the consumption within the service domain with a corresponding consumption threshold. The threshold is thus a threshold that is dedicated to the service domain and more particularly to the specific service provider of the service domain.

The threshold may furthermore be a threshold set to a value in the unit in which consumption is made. If for instance the service or utility in the service domain is the supply of gasoline, the threshold could be set to be a number of litres of gasoline.

If then the consumption of the user in the service domain in the time interval to be billed does not cross the threshold, step 60, and in this case does not exceed the threshold, the billing engine 40 is informed and normal billing is performed. In this case a normal agreed or default rate plan for the consumption may be used.

If however the threshold is crossed, step 60, and in this case exceeded, the promotions calculator 38 gives the user at least one reward, step 62. This reward is a reward, such as a bonus and/or a discount, in relation to at least one other service domain than the one for which the comparison is made. In some instances it may also give a reward in relation to the utility for which the comparison is made. The promotions calculator 38 may thus give a first reward in relation to the service domain for which the consumption was compared as well as at least one further or second reward for another or further service domain, step 62. It should here also be realized that there may be more than one threshold and that further rewards may be given for every threshold being crossed.

Optionally the promotions calculator 38 may also here inform the user of the rewards via the input output unit 50 and possibly also await a response from the user that he or she accepts one or both of them. It may thus offer the user at least one of the rewards and the user may accept or decline.

When the rewards have finally been set, the billing engine 40 is informed.

The reward may be provided in a number of different ways. It may be a bonus or a discount. It may also be both a bonus and a discount. A reward may be a fixed offset that is deducted or added to the billing made in a service domain. It may also be a rate change, such as a rate decrease or a rate increase that is to be applied when billing the usage of the service for which a reward is given.

The above described type of comparison is thus done for a number of service domains. It is for instance possible that also the consumption made in the domain in which the user has received a second reward is compared with a corresponding threshold and it is in the same way possible that the usage in the service domain of the second reward, leads to a reward from yet another service providing entity if a threshold is crossed for the second service providing entity.

The promotions calculator 38 may in the determination of a reward in relation to one crossed threshold for one service provider consider a previously given reward associated with the same service provider and given in relation to a previously crossed threshold for another service provider. It is for instance possible that no first reward is given for consumed utilities of one service providing entity if a reward has already been given in another context. However, it is then still possible that a second reward is given in relation to a further service providing entity.

After all rewards have been determined, the billing engine 40 computes a bill for the user U1, step 64. This may be done through the billing engine 40 summing the different billings made for the first user U1 by the rules engine 34 according to the different billing or rate plans and applying the rewards that are applicable according to the promotions calculator 38. Thereby data that can be used for forming a bill is obtained.

The billing engine 40 therefore computes a bill based on the degree of consumption within all service domains using corresponding charging rates while considering rewards given to the user, step 64, The billing engine will in this case only consider an offered reward if it was accepted by the user. The bill may then be sent to the user by the input output unit 50, perhaps after having received further information also from the billing device 23, step 65. The input output unit 50 thus bills the user using the computed bill with possible rewards. In this bill the rewards accepted by the user may thus be included.

The proposed new solution will handle cross channel charging and billing and can generate a single bill for multiple channel usage combined with cross domain promotions.

It can thus be seen that other types of billing is brought into a communication environment of a user, such as into the telecom system used by a user, as the telecom system already has the infrastructure to handle such kind of data. With this diverse information it is possible to increase the revenue of the operator of the communication environment and be able to make the mobile number a kind of identification for the user and be able to seamlessly handle information across domains and provide the end User as well as the Vendors with benefits.

Moreover, the herein described procedure is able to explore the close integration of the Billing arrangement with evolving mobile Wallet techniques, which allows operators to rapidly offer mobile-money services to prepaid and post-paid subscribers. The rapid uptake of mobile money services is said to be fuelled by a surge in mobile phone use, and major mobile money service providers are now investing in supporting architecture. A recent report predicts active users of mobile money services in emerging markets to show a 36 percent annual growth rate, resulting in an increase from 61 million users in 2011, to 381 billion by 2017. Hence it opens the door to new revenue streams for the operator, and helps reduce churn by bringing added value to subscribers. To utilize the mobile phone for banking errands is further predicted to be seen among both banked and unbanked users in the future, according to the report. The study also notes that in countries such as Bangladesh. Pakistan, India, Nigeria, Mexico, and Argentina, mobile money services have successfully matured in the market, aiming to bank the unbanked and create new opportunities for local merchants

It can also be seen that the rules engine 34 has a functionality to calculate various charges for users (customer/subscriber) and may comprise configurations for granting of cross domain promotions. The rules engine 34 may furthermore be responsible for maintaining thresholds associated with service domains and used for cross-promotions and also help the arrangement to notify the subscriber about a reached threshold.

The rules engine 34 has access to the rules configuration store 36. The rules configuration store 36 in turn comprises details of consumption units in various service domains and the tariff for calculating different biller and vendor charges for the used units of the user.

The Rules engine 34 may furthermore here use the input output unit 50 to inform the subscriber/Customer about a threshold breach.

The Promotions Calculator 38 in turn has the role to grant the cross domain promotions. For this it may make use of the rules configuration in the rules configurations store 36. The promotions calculator 38 may also be aware of thresholds upon which a subscriber is to be granted various rewards according to various cross domain promotion schemes. The Promotions Calculator 38 may also use the input output unit 50 to inform the customer about the granted reward. Furthermore, if a reward, such as a change of the charging rate in a service domain, is granted to the user in this change may then also be reported by the promotions calculator to the service providing entity of the service provider.

The Billing Engine 40 may be used to produce a final bill for the user. The billing engine 40 has access to the billing configurations store 42 in which the customer/subscriber will be able to customize bill cycles. The Billing Engine 40 will also have the capability for generating the bills for the vendors.

Each cross domain promotions may be configured as a rate plan in the rules engine. The promotions calculator 38 may use this information to apply a promotions package to the user taking into account options selected by the user.

Hence, aspects of the invention employ the following features:
Device to core network communication through a common interface, here in the form of the input output unit
Reception of information for every usage event
Real time online unified billing system built in with cross domain promotions

Optionally there is also a creating of a separate record associated with a domain, for later usage, such a record is here termed a usage data record (UDR).

The Input Output Unit 50 has, apart from communicating with the user/customer, the role of listening on any demand service request from the user. This gets the corresponding information from the data network 52 and sends it back. It is also used to send out a message to the end user about the details of his or her usage and to provide information about bills pending for clearance. The input output unit 50 may thus receive a status query from the user concerning the consumption in one or more of the service domains and respond to this query with data about the consumption.

The Input Output unit 50 may have a small memory segment which captures the data related to a particular period, sends an accumulated notification to the configured customers and clears the data after the end of the period. The Input output unit 50 may also have the capability to store UDRs for further processing for a defined period of time. This enables the arrangement to wait for the user response in selecting an eligible promotion. If the user has not responded with an option the promotions calculator may apply a default promotion suitable for the transaction. In case the user changes his MSISDN then the input output unit 50 may inform the change in MSISDN to the service providing entities for updates and future communication. The input output unit may thus receive a change of telecommunication network identifier of the user. When this received it will make required updated within the arrangement such as in the database 46 and in UDRs. It will also inform the service providing entities of the different service domains of the change.

As described earlier, the main purpose of the Data Network 52 is to enable the processing of data by each element inside the billing arrangement asynchronously.

The Data network 52 may maintain a queue which is used by the elements to write and read information, for instance through employing the buffer 55.

The data manipulator 54, rules engine 34, promotions calculator 48, billing engine 40 and input output unit 50 may each implement a corresponding process which may write data to the data network 52 with an own process id and also write information about a subsequent process which has to read this data. The data written by such a process can use the below format.

<Id of writing process> <Id of Reading Process> <Information (Processed UDR)>

The underlying data of the complete system like UDR Information, Rule configuration, Billing Configuration, Promotions Configuration, customer information etc. may be stored in the database 46. Depending on the volume of data the storage medium can be chosen.

The Subscriber profiler 48 may be responsible for introducing analytics on the customer spending behaviour. Various customer-centric reports can be generated based on the configuration, for example Weekly/monthly/yearly to enable them to streamline their spending's:

1. total utility spending

2. category wise spending etc.

There may furthermore be a number of units in the network billing device 23. There may for instance exist an Account Finder, which may be used to find the subscribers billing account and recharge the value. The account finder may thus be a network element that provides location information for subscriber accounts in the mobile network 20. It stores the Session Description Protocol) Identity SDP ID and the related IP address for each MSISDN in the mobile network 20. The account finder may be co-located with an Account information refill (AIR) unit, which is also a part of the billing device 23. The account information refill unit is the one which handles all the type refill requests to a subscribers billing account.

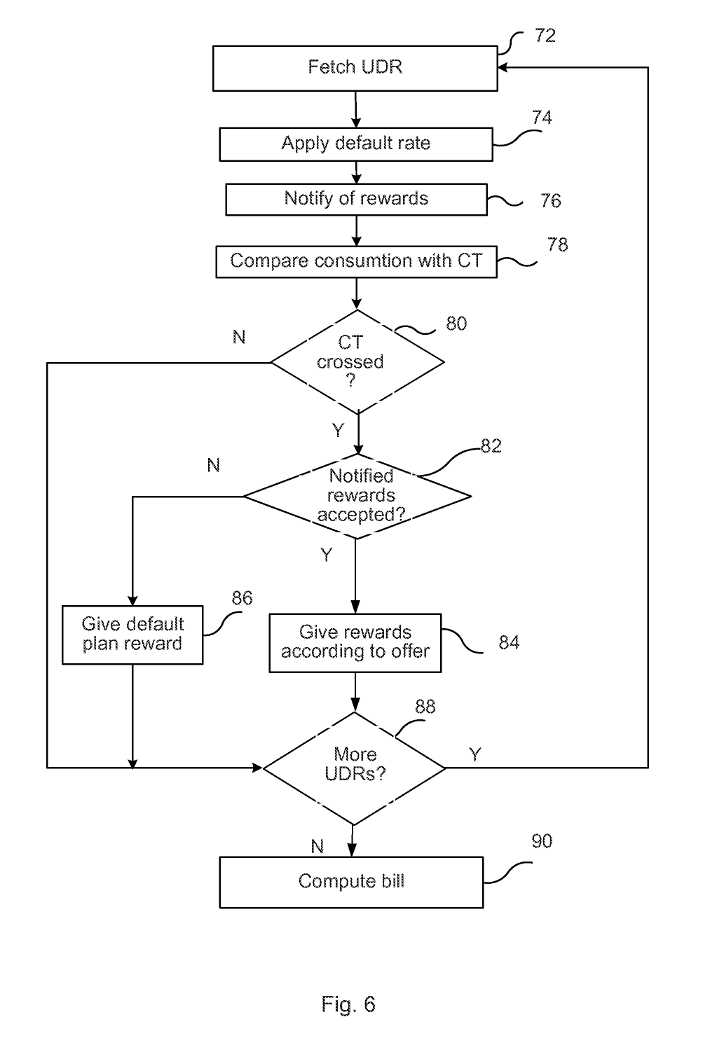

Now a second embodiment that employs UDRs will be described with reference being made to FIG. 5, which shows a number of method steps being performed by the billing arrangement for obtaining UDRs, and to FIG. 6, which shows a flow chart of method steps in a method for providing unified billing of the consumption made by a user according to a second embodiment.

In this embodiment, a utility device of a service providing entity, such as a utility device of the first service providing entity 24, is capable of sending usage information to the billing arrangement 22.

The utility device may here send the event details, i.e. usage information, to the core network (Like common core network (CCN) or charging and billing system) of the mobile network 20 through a common interface (gateway), which common interface may be provided through the input output unit 5o.

The usage data may then be sent in a message having the following mandatory fields:

1. Device Id

2. Unique subscriber identifier

3. Usage Units

4. Date and Timestamp

This data may furthermore be organized in the following way:

1. Header <Device Id, Unique subscriber identifier, Date and Timestamp>

2. Body <Usage Units>

In such a message the device id may be an identifier of the specific utility device in the service providing entity that has delivered the units of the service or utility to the user U1 or a central device that supplies such delivery information, the unique subscriber identifier may be the MSISDN of the mobile station 10, the usage units may be the number of units of the service or utility that has been delivered to or consumed by the user U1 and the date and time stamp may be time indications indicating the time of purchase, delivery or consumption of the units. These messages may be sent to the input output unit 50.

In this way the input output unit 50 receives messages from the service providing entities, step 66.

The input output unit 50 may then forward these messages to an authentication layer of mobile communication system 20, which may as an example be provided by the billing device 23. Thereby the data sent by the utility device described above reaches the Authentication layer of the billing device 23, which may investigate if there is a user in the system 20 that corresponds to the user identifier. The Authentication layer may also validate the received data by using a secured key verification method. If it is a valid subscriber, the information will be passed on in the system. Otherwise it will not be processed. In this case the billing device 23 may inform the input output unit 50, which may in turn inform the service providing entity that the subscriber is unknown.

Authenticated user data may be passed to a “Processing logic” service inside the core network, which may classify the usage data and separate it from normal traffic related data, i.e. data concerning communication sessions of the mobile terminal 10. The data packets with unit usage information may then be sent to the Data Manipulator 54. It is here possible that the separation of data is made by the input output unit 50. As an alternative there may be no mixture of data and thus no need for separation.

The Data Manipulator 54 receives the messages or data packets and may use the capability of the core network to retrieve subscriber details, i.e. data about the first user U1. It also formats the data packets into a UDR format which is easily identified by the Billing engine 40. It thus creates uniform usage data records based on the content of the messages, step 68, where there may be one usage data record generated for every domain or rather for every service providing entity. The UDRs may furthermore be categorized based on domain. A data record may be created once and then provided to the storage processor 44 for storage in the database 46. The UDR may then be fetched and updated by the data manipulator 54 every time usage data associated with the corresponding service providing entity is received. The data manipulator 54 may more particularly create an UDR when usage data in a new billing cycle is received.

Each and every utility event is thus captured and recorded in the UDR format into the arrangement for future billing purpose as well as on demand notifications.

The UDR may comprise data specifying the degree of consumption and the service domain. The UDR format may therefore at least initially look in the following way:

event Id, number of units, and user identifier,

where the event id may reflect a service providing entity as well as possibly also

utility devices within the service providing entity.

The data manipulator 54 may also write the UDR data into the Data Network 52 with a process id indicating that the rules engine 34 is to process it, for instance a process id 2. The data manipulator 54 may thus store the UDR in a buffer of the data network, such as in the FIFO buffer 55, which will be read by the Rules Engine 34 for further processing. In this way the UDR is stored, step 70.

In the case of storing the UDR in the buffer 55, the Rules Engine 34 may be set to read all UDRs stored with the process id 2. As the buffer 55 is a FIFO buffer, it will thus read a UDR with the process id 2 in FIFO manner. It will thus fetch a UDR with process id 2 from the FIFO buffer 55, step 72, and apply the configured rules for that service and user as specified in the rules configuration store 36. The rules configuration store 36 may comprise various rate plans dedicated to the different domains. The rules engine 34 may thus apply the rates of the usage according to a default rate plan for the user U1 in the domain defined by the UDR, step 74. It will then append the calculated charges to the UDR and put the processed UDR back into data network (buffer 55) with process id 3, which indicates that cross-domain promotions is to be investigated. The rating is thus applied on the UDRs based on the rate plan and stored along with the UDR.

The Rules engine 34 may be responsible for monitoring a particular usage in relation to a first threshold. It may more particularly compare the consumption of a unit with a first threshold. This first threshold may be user specified. It may also be set by the billing arrangement 22. In case the first threshold is crossed, then the rules engine 34 may append data that the threshold has been crossed to the UDR. It may then also write the UDR with process id 5 into buffer 55, where process id 5 may signal that input output unit 50 is to handle the UDR. In this way the rules engine 34 instructs the input output unit 50 to notify the user U1 of the threshold being crossed, which may be accompanied by information of promotions or rewards, such as bonuses and/or discounts, that may be available to him or her. It may in this way in fact offer the user the rewards. The first threshold may be a threshold set just below the consumption threshold used by the promotions calculator 38. It may be used as an indicator for the user the he or she will soon be eligible for one or more rewards. It may also be the consumption threshold that is decisive for cross-domain promotions.

The Input Output unit 50 may fetch the UDR with process id 5 and then notify the user U1 of the eligible promotions, step 76. As it waits for a response by the user U1, the input output unit 50 may temporarily store the UDR in an own memory segment. If the user responds with an option of accepting notified rewards, the acceptance is received by the input output unit 50. The input output unit 50 may then retrieve the corresponding UDR and append the selected promotion option to the UDR and write it to the data queue in the buffer 55 with process id 3.

It can thus be seen that the usage can be tracked and notifications on exceeding the first threshold can be notified to the user U1. A user may also investigate the system with regard to the own usage in the various domains. The user may thus send a query regarding the status of his or her consumption in one or more of the service domains. When the input output unit 50 receives such a request concerning the consumption in a domain, it may fetch the corresponding UDR from the database and send the consumption data as well as possibly the rate plan therein to the user.

The promotions calculator 38 is responsible for determining of if rewards are to be handed out or not. The Promotions calculator 38 may for this reason read the UDR with the process id 3 in FIFO manner.

As it is responsible for promotions, it monitors the consumption of the user with regard to a cross-promotions decisive consumption threshold for the end user U1. The promotions calculator 38 may thus compare the consumption of the user in the UDR with a consumption threshold that is decisive for determining cross-domain promotions, step 78. It thus compares the data specifying the degree of consumption in the usage data records associated with the service domain with the consumption threshold. This consumption threshold may the same or a different threshold than the first threshold. In case the threshold is not crossed, step 80, then promotions calculator 38 may put the processed UDR back into data network (buffer 55) with process id 4, which indicates that billing is to be made. In this case no data is added to the UDR.

However, if the threshold is crossed, step 80, the promotions calculator 38 will apply cross domain promotions, in which case it may give rewards. It may here give a first reward in relation the service providing entity in which the usage is made and a second reward for another service providing entity. The rewards may be determined based on many factors like a catalogue in rules configuration store, subscriber history information from database 46, credit history and other promotional factors (eg. seasonal, time of day etc.). The promotions calculator 38 has also the capability to use a promotion option selected by the end user. If the user U1 has not opted for any promotion, step 82, a default promotions option from the catalogue may be applied as configured in the rules configuration store. In this case a default plan reward may thus be given, step 86.

However, if the offered rewards were accepted, step 82, the rewards of the offer will be given, step 84.

IF the first threshold is the consumption threshold used for deciding cross-promotions, is here possible that the rules engine 34 adds information to the UDR indication that the threshold has been crossed. It is in this case possible th the promotions calculator 38 does not perform any new comparison with the threshold, but merely acts on this information.

The promotion information may be appended to the processed UDR and put in the data network with process id 4. The promotion information may also be written as a separate UDR with process id 5 into data network.

The input output unit 50 will read the UDR with process id 5 in FIFO manner. Thereby the input output unit 50 will send notifications according to a preferred format (e.g. daily, weekly etc.) in a preconfigured way (e.g. SMS, mail etc.) to the end user U1 about the eligible promotions.

As a currently processed UDR has been handled in the above described way the rules engine 34 and promotions calculator 38 will investigate if there are further UDRs with process ids indicating that they should operate on them for the user U1. If there are, step 88, then the rules engine 34 will apply the default rate associated with the UDR on the usage, step 74, the input output unit 50 notify possible rewards, step 76, and the promotions calculator 38 compare the consumption with the consumption threshold of the domain, step 78, and give possible rewards, steps 84, 86 based on threshold crossing, step 82, while if there are no further UDRs then the billing engine 40 will compute the bill for the user, step 90.

Thus when there are no further UDRs to be investigated with regard to threshold crossing for the user U1, and the billing configurations store 42 indicates that billing is to be made, the Billing Unit 40 will process id 4 in FIFO manner and compute a bill based on all UDRs of the user U1, step 86. It will thereby compute a bill based on the degree of consumption in the usage data records. At the end of the period specified in the billing configurations store 42, the bill is thus generated with the applied eligible opted discounts and promotions. The generated bill is then notified to the customer, for instance via the input output unit 50. It is also possible that the billing engine 40 deletes the UDRs after having formed and sent a bill and new UDRs are created in the following billing cycle.

It can thus be seen that on a preconfigured period, i.e. at recurring regular intervals like end of the month, the UDR for that period for every domain is accumulated and based on the value, the applicable promotions are applied and a final bill generated. Since the system is an online system, at any point of time on demand, the unbilled usage information's can be obtained by the user.

It can thus be seen that cross-domain promotions is achieved with the help of pre-configured information which may be available in the database. Moreover, the proposed solution is a continuous online solution, where data from various utility devices is automatically collected at every event process through dedicated common interface and helpful to generate the unified bill. In the proposed solution, the utility devices are smart enough to be able to directly communicate with the core network through device specific protocols (eg. SS7, ANSI etc) through common interface and each utility devices communicates for every event occurred.

The proposed new solution is capable of handling every usage events coming from the cross channel Utility devices through the input output unit as well as it can provide cross channel information to the end user on a demand basis.

The rate plans and the cross domain promotion rules may as an alternative be stored in a cloud based on the operator configurations. Each domain is considered as a service in the rate plan. Customer is assigned with a opted rate plan. The rating is applied on each UDR based on the rate plan (before discounts) and stored along with UDR.

Now will follow a number of examples on how the arrangement may be operated.

For example, consider the case of telephony usage and electricity usage. If a customer has used more than rs.1000 in telephony and more than rs.100 in electricity, he or she can get a discount of rs.10 in electricity. In this case, the telephony operator attracts the users who are using telephony for only rs.500 towards this promotion and can share the discount of rs.10 from his additional profit.

Also, in another promotion the more Electricity usage can offer some discounts in the telephony usage which will be the reverse of above. From this, both the service providers can get benefits of more usage through mutual handshake in case of third party service providers. This discount information's is notified to third party service provider through input out unit. The input output unit may employ a common API, through which third party information's can be received or transmitted. In case of multi-domain service providers, this can be used to attract users towards the lean usage services.

The benefit for the end user is then that he or she can analyse the own spending and can set thresholds to each domain to get alerts on nearing them.

Now will follow a scenario of handshake happening between the core network operator and other service providers like cable tv operator, broadband service providers etc.

A willing small service providers can avail the benefits of large consumer base and can get the benefits of the big brand. In this case, it works in the same way as like previous scenario. The received data from the other service provider is also authenticated in the same way. It is sent to the next process, based on the contract between the core network operator and the other operator.

Another example is Electricity/Water/Gas Billing.

As mentioned earlier a service providing entity that captures the electricity usage will send the usage information to the arrangement 22 in a periodic interval.

The information could include the following mandatory details:

1. Device Id<EMR>

2. Unique subscriber identifier <RT0000001>

3. Current Usage Units <00500>

4. Date and Timestamp <12/27/201315.06>

The Authentication layer of the billing device 23 may validate the received electricity usage information. The Data Manipulator 54 on receiving the data identifies the subscriber and formats the data packets into a UDR and writes into the Data Network 52.

The Rules Engine 34 will apply the configured rules for Electricity service, and append the UDR with the calculated charges. This will be saved in the database 46 for further reference.

The Notification on nearing the threshold may then be sent by the Input Output unit 50. After sending the information about the eligible promotion the arrangement then waits for a response by the user U1. If the user U1 responds with an option the arrangement uses it, else it applies a default configured option.

On demand a user can be notified of the current usage of a consumed utility.

All the eligible and available promotions (cross channel) are notified for the end user to avail it. At the end of the period (configured), the bill is generated with the applied eligible opted discounts and promotions. The generated single bill is then notified to the user.

Above the combination of Electricity Billing/Water/Gas billing was described. Now another scenario will be given in order to explain how the service providing entity sends the details to event queue in the billing device 23 through the dedicated interface and how the process is done to generate a single utility billing.

Petrol bunk post paid billing scenario:

Petrol vending machine will be equipped with a device. While filling fuel, the device requires the unique subscriber identifier.

After the event the following information is sent to the arrangement.

1. Device Id

2. Unique subscriber Identifier

3. Usage Units

4. Timestamp

With the device id, the system will be able to identify the product (petrol or diesel) and the vendor. The rate plan is then mapped with the device id. This information reaches the authentication layer, and follows the same procedure as previous examples.

The rated UDRs will then have the following information:

1. Event Id

2. Used Units

3. Amount

At the configured bill generation time, for that particular subscriber, all the UDRs are aggregated event wise.

ex. One UDR for electricity, gas, water, petrol etc.

Cross Recommendations:

Now the procedure for cross domain promotions and how the rule engine executes these promotions will be described.

The configured discounts may be received by the promotions calculator 38 from the rules engine 34.

### Example 1

Petrol consumption more than rs. 100/− will get a discount of 10% on EB consumption.

### Example 2

If EB consumption is less than Rs. 50/− will get a discount of 5% in water consumption.

### Example 3

If gas consumption is between Rs. 300/− to rs. 600/− will get a discount of rs.10 on petrol consumption.

For example discount 1, if the aggregated UDR from petrol event crosses rs.100/−, then a discount of 10% will be applied on the aggregated UDR of EB event for that subscriber, for that bill period.

All the discounts may be checked for eligibility and applied if satisfied. Then the consolidated single bill is generated after applicable discounts. The generated bill is notified to the customer. The same procedure is applicable for on demand bill generations.

The above described arrangement has a number of advantages.

1. It enhances customer experiences with targeted, multichannel mobile loyalty programs that convert points and rewards into lasting loyalty and advocacy

2. It delivers personalized, 1-to-1 offers in real-time—across multiple channels—to improve conversion rates, grow revenue, and build customer loyalty

3. It introduces flexible mobile payment options to consumers—such as micropayments, bill pay, and top-ups—with this innovative, end-to-end solution

4. It offers mobile banking services that reach and engage new customer segments—including the unbanked and underbanked

5. It offers access to financial services via any mobile device, including feature phones and smart phones

6. It satisfies consumer demand for self-service enablement, and benefit from reduced support costs

7. Mobile payment method is started growing popular all over the world and it provides the benefits like Security, Convenience, Easy, Fast and Proven

8. The proposed architecture follows more on an operator centric model may be extended to collaboration model to support the collaborations among banks, other mobile operators and third parties.

There are also several advantages for the end user. The user can receive notifications on unbilled usage and plan the future spending. The user can receive comparative analysis on his usage between last billing period and current. The user can avail the benefit of single bill and single payment for multiple billers. The user can enjoy cross domain promotions and customizations. Mobile usage is comparatively more than bank account usage. Mobile users may with this system be made to pay their bills without defaulting. Cash transactions can be minimized Tracking of currency transactions is more transparent.

There are also several advantages for the operators. They can charge subscription fees for single bill payment service. They can charge subscription fees for notifications on parameters like spend analysis, threshold breach. The can utilize the information of user categories like high spenders for other service promotions. They can use this data for more customized promotions. Through mobile money payment, they can get a huge money flow into the network. Existing billing device operators can handshake with small other segment service providers and have a mutual win benefit. For a multi segment service provider, it is easy to track all the bills through single gateway.

There are a number of different variations that are possible to make of the billing arrangement apart from those already described. It is for instance possible to omit the subscriber profiler. It is also possible that the input output unit is divided into different sections, one section for communicating with he user and another for communication with service provider.

The billing arrangement 22 may, as was mentioned initially, be provided in the form one or more processors with associated program memories comprising computer program code with computer program instructions executable by the processor for performing the functionality of the privacy retaining arrangement.

The computer program code of a billing arrangement may also be in the form of computer program product for instance in the form of a data carrier, such as a CD ROM disc or a memory stick. In this case the data carrier or memory stick carries a computer program with the computer program code, which will implement the functionality of the above-described billing arrangement. One such data carrier 88 with computer program code 90 is schematically shown in FIG. 7.

Furthermore the input output unit of the billing arrangement may be considered to form means for continuously receiving messages from a variety of service providing entities, where the messages are associated with consumption of the user in a variety of service domains as well as means for billing a user using a computed bill.

The promotions calculator or the rules engine may be considered to comprise means for comparing, for at least some of the service domains, the consumption within the service domain with a corresponding consumption threshold.

The promotions calculator may further be considered to comprise means for giving the user at least one reward if the consumption threshold is crossed,

The billing engine may in turn be considered to comprise means for computing a bill based on the degree of consumption within all service domains using corresponding charging rates while considering rewards given to the user.

The promotions calculator may furthermore be considered to comprise means for giving a first reward in relation to the service domain for which the comparison is made as well as at least one further reward in relation to the at least one further service domain.

The rules engine or the promotions calculator may furthermore be considered to comprise means for offering the user at least one of the rewards and the promotions calculator may be further considered to comprise means for only considering an offered reward in the billing if it is accepted.

The data manipulator may in turn be considered to comprise means for creating uniform usage data records based on the content of the messages, where a usage data record comprises data specifying the degree of consumption and the service domain.

The means for comparing the consumption with a corresponding consumption threshold may furthermore be considered to form means for comparing the data specifying the degree of consumption in the usage data records associated with the service domain in question with the threshold and the means for computing a bill may be considered to form means for computing a bill based on the degree of consumption in the usage data records.

The input output unit may furthermore be consider to comprise means for receiving a status query from the user concerning the consumption in one or more of the service domains and means for responding to the query with data about said consumption.

The promotions calculator may furthermore be considered to comprise means for obtaining a change of the charging rate of the user in relation to a service domain and means for reporting said change to a corresponding service providing entity.

The input output unit may furthermore be considered to comprise means for receiving a change of telecommunication network identifier of the user and means for reporting the change to the service providing entities.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims.

1. A billing arrangement for providing unified billing of the consumption made by a user in a number of different service domains, the billing arrangement comprising a processor acting on computer instructions, whereby said billing arrangement is operative to:
continuously receive messages from a variety of service providing entities, said messages being associated with consumption of the user in a variety of service domains;
compare, for at least some of the service domains, the consumption within the service domain with a corresponding consumption threshold;
if the consumption threshold is crossed, give the user at least one reward in relation to at least one further service domain;
compute a bill based on the degree of consumption within all service domains using corresponding charging rates while considering rewards given to the user; and
bill the user using the computed bill with possible rewards.

2. The billing arrangement according to claim 1, wherein said billing arrangement is further operative to give at least one reward by being operative to give a first reward in relation to said service domain as well as at least one further reward in relation to said at least one further service domain.

3. The billing arrangement according to claim 1, wherein said billing arrangement is further operative to notify the user of at least one reward and only consider a notified reward in the billing if it is accepted.

4. The billing arrangement according to claim 1, wherein said billing arrangement is further operative to create uniform usage data records based on the content of the messages, where a usage data record comprises data specifying the degree of consumption and the service domain, when being operative to compare the consumption with a corresponding consumption threshold is operative to compare the data specifying the degree of consumption in the usage data records associated with the service domain in question with the threshold and when being operative to compute a bill is operative to compute a bill based on the degree of consumption in the usage data records.

5. The billing arrangement according to claim 1, wherein said billing arrangement is further operative to bill the user at recurring regular intervals.

6. The billing arrangement according to claim 1, wherein said billing arrangement is further operative to receive a status query from the user concerning the consumption in one or more of the service domains and respond to said query with data about said consumption.

7. The billing arrangement according to claim 1, wherein said billing arrangement is further operative to obtain a change of the charging rate of the user in relation to a service domain and report said change to a corresponding service providing entity.

8. The billing arrangement according to claim 1, wherein the association of the messages to the specific user is made using a telecommunication network identifier of the user.

9. The billing arrangement according to claim 8, wherein said billing arrangement is further operative to receive a change of telecommunication network identifier of the user and report said change to the service providing entities.

10. The billing arrangement according to claim 1, wherein said billing arrangement is provided as a part of a telecommunication system.

11. The billing arrangement according to claim 10, wherein said billing arrangement is provided in the core network of a mobile communication system.

12. A method for providing unified billing of the consumption made by a user in a number of different service domains, the method being performed in a billing arrangement and comprising:
continuously receiving messages from a variety of service providing entities, said messages being associated with consumption of the user in a variety of service domains;
comparing, for at least some of the service domains, the consumption within the service domain with a corresponding consumption threshold;
if the consumption threshold is crossed, giving the user at least one reward in relation to at least one further service domain;
computing a bill based on the degree of consumption within all service domains using corresponding charging rates while considering rewards given to the user; and
billing the user using the computed bill with possible rewards.

13. The method according to claim 12, wherein the giving of at least one reward comprises giving a first reward in relation to said service domain as well as at least one further reward in relation to said at least one further service domain.

14. The method according to claim 12, further comprising:
notifying the user of at least one reward and only considering a notified reward in the billing if it is accepted.

15. The method according to claim 12, further comprising:
creating uniform usage data records based on the content of the messages, where a usage data record comprises data specifying the degree of consumption and the service domain, wherein the comparing of the consumption with a corresponding consumption threshold comprises comparing the data specifying the degree of consumption in the usage data records associated with the service domain in question with the threshold and the computing of a bill comprises computing a bill based on the degree of consumption in the usage data records.

16. The method according to claim 12, wherein the billing is made at recurring regular intervals.

17. The method according to claim 12, further comprising:
receiving a status query from the user concerning the consumption in one or more of the service domains and responding to said query with data about said consumption.

18. The method according to claim 12, further comprising:
obtaining a change of the charging rate of the user in relation to a service domain and reporting said change to a corresponding service providing entity.

19. The method according to claim 12, wherein the association of the messages to the specific user is made using a telecommunication network identifier of the user.

20. The method according to claim 19, further comprising:
receiving a change of telecommunication network identifier of the user and reporting said change to the service providing entities.

21. The method according to claim 12, wherein the billing arrangement is provided as a part of a telecommunication system.

22. The method according to claim 21, wherein the billing arrangement is provided in the core network of a mobile communication system.

23. A computer program product for providing unified billing of the consumption made by a user in a number of different service domains, the computer program product being provided on a non-transitory data carrier comprising computer program code which when run in a billing arrangement, causes the billing arrangement to:
continuously receive messages from a variety of service providing entities, said messages being associated with consumption of the user in a variety of service domains;
compare, for at least some of the service domains, the consumption within the service domain with a corresponding consumption threshold;
if the consumption threshold is crossed, give the user at least one reward in relation to at least one further service domain;
compute a bill based on the degree of consumption within all service domains using corresponding charging rates while considering rewards given to the user; and
bill the user using the computed bill with possible rewards.
